(19) United States
(12) Patent Application Publication
(10) Pub. No.: US 2020/0214114 A1
(43) Pub. Date: Jul. 2, 2020

(54) LAMP INCLUDING ANTENNA ASSEMBLY AND LIGHT SOURCE BOARD ASSEMBLY

(71) Applicant: XIAMEN ECO LIGHTING CO. LTD., Xiamen (CN)

(72) Inventors: Chihhsien Wu, Xiamen (CN); Renhua Zhou, Xiamen (CN); Shuifa Guo, Xiamen (CN); Fuyuan Wu, Xiamen (CN); Zhu Li, Xiamen (CN); Pofeng Peng, Xiamen (CN)

(21) Appl. No.: 16/726,914

(22) Filed: Dec. 25, 2019

(30) Foreign Application Priority Data
Dec. 28, 2018 (CN) 201822240974.3

(51) Int. Cl. H05B 47/19; F21V 33/00; F21V 23/04; H01Q 1/38; F21W 111/00

(52) U.S. Cl. CPC H05B 47/19; F21V 33/00; F21W 2111/00; H01Q 1/38; F21V 23/0435

(57) ABSTRACT

A lamp includes an antenna assembly and a light source board assembly. The antenna assembly includes a radio frequency board, a first ground connection portion disposed on the radio frequency board and connected to ground portions of other parts of the lamp, a radio frequency module and an antenna. The radio frequency module and the antenna are integrated on the radio frequency board and respectively connected to the first ground connection portion. The light source board assembly includes a base board and a light source disposed on the base board. The radio frequency board stacks on the base board. The light source is not covered by the radio frequency board. The radio frequency board transceiver signals without being blocked, so the signals are strong enough to make stable communications. The radio frequency board does not pass through the base board, so manufacture process is simpler, and manufacturing cost is reduced.

### BACKGROUND OF THE INVENTION

### 1. Field of the Invention

The disclosure is related to a lamp, and more particularly, a lamp including an antenna assembly and a light source board assembly.

### 2. Description of the Prior Art

As shown in FIG. 1, in a lamp on the market, a radio frequency module and an antenna are often integrated on a radio frequency board 11 to act as a module operating independently. However, if the radio frequency board 11 is surrounded by a metal part such as a riveting cover 12 or a heat dissipation part 13, the radiation of the antenna will be reduced, and the stability of communications will be relatively poor.

### SUMMARY OF THE INVENTION

The disclosure provides a lamp used for reducing problems of poor antenna radiation and unstable communication of a lamp of prior art.

An embodiment of the disclosure provides a lamp including: an antenna assembly including a radio frequency board, a first ground connection portion disposed on the radio frequency board, a radio frequency module and an antenna where the radio frequency module and the antenna are integrated on the radio frequency board and are respectively connected to the first ground connection portion; and

a light source board assembly including a base board and a light source disposed on the base board where the radio frequency board is disposed to stack on the base board, the light source is disposed to be not covered by the radio frequency board, and the first ground connection portion is connected to ground portions of other parts of the lamp.

Optionally, the light source board assembly may further include a second ground connection portion disposed on the base board, and the second ground connection portion is connected to the first ground connection portion correspondingly.

Optionally, the lamp may further include a heat dissipation part connected to the base board.

Optionally, the second ground connection portion may further be welded to the first ground connection portion, and the second ground connection portion may be screwed to the heat dissipation part.

Optionally, the lamp may further include a fixing cover connected to the radio frequency board.

Optionally, the second ground connection portion may be welded to the first ground connection portion, and the second ground connection portion may be screwed to the fixing cover.

Optionally, the first ground connection portion may include a spring terminal, and the spring terminal may pass through the base board to contact the fixing cover.

Optionally, the base board may have a pass-through slot used for the spring terminal to pass through.

Optionally, the fixing cover may have an open slot corresponding to the antenna.

Optionally, the base board may have a gap configured for a part of the radio frequency board to be exposed, and the antenna may be integrated on the part of the radio frequency board.

The lamp provided by an embodiment may have following useful effects.

First, a radio frequency board integrated with a radio frequency module and an antenna is disposed to stack on a base board, and a first ground connection portion disposed on the radio frequency board may be connected to other parts of the lamp, so the other parts of the lamp may be used as antenna radiation parts. Hence, the radio frequency board may transceive signals without being blocked, the signals may be strong enough to make stable communications. Second, regarding prior art, a lamp of prior art may have a radio frequency board inserted through a light source board where an antenna and a radio frequency module are integrated on the radio frequency board; however, the radio frequency board of the present disclosure may not pass through the base board. In other words, it is unrequired to cut an opening on the base board for inserting the radio frequency board, so manufacture process is simpler. Moreover, the radio frequency board integrated with the radio frequency module and the antenna may independently transceive signals to exchange data to achieve effects of an internet of things (IoT) lamp, and the highly integrated radio frequency board may facilitate mass production and subsequent installation. Furthermore, according to prior art, a radio frequency board may protrude excessively high so as to block light emitted from a light source board and reduce light efficiency of the light source board; however, according to the present disclosure, the radio frequency board may be disposed to stack on the base board instead of protruding on the base board. Hence, according the present disclosure, light emitted from a light source may not be blocked by the radio frequency board, and the light efficiency of the light source may be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an exploded view of a three-dimensional structure of a lamp including an antenna assembly according to prior art.

FIG. 2 illustrates an exploded view of a three-dimensional structure of a lamp including an antenna assembly according to an embodiment.

FIG. 3 illustrates a base board from a bottom view according to an embodiment.

FIG. 4 illustrates a three dimensional structure of an antenna assembly and a fixing cover from another perspective according to an embodiment.

### DETAILED DESCRIPTION

In order to make the technical problems solved by the present disclosure and technical solutions and beneficial effects related to the present disclosure to be more clearly understood, the present disclosure will be further described in detail with reference to drawings and embodiments as follows. It should be understood that the embodiments described herein are only used to explain the present disclosure and are not intended to limit the present disclosure.

It should be noted that when an element is referred to as being “fixed to” or “disposed on” another element, it may be directly located on another element or indirectly located on another element. When an element is referred to as being “connected to” another element, it can be directly connected or indirectly connected to the other element.

It should be understood that directions or locations related to the terms such as “length”, “width”, “higher position”, “lower position”, “front”, “back”, “left”, “right”, “vertical”, “horizontal”, “top”, “bottom”, “inside” and “outer” may be related to the directions or the locations shown in the drawings and be merely used to conveniently described the disclosure rather than indicating that a device or an element must be built or operated in specific directions. Hence, directions and orientations mentioned herein are not used to limit the present disclosure.

In addition, the terms “first” and “second” herein are merely used for description instead of limiting importance or number of elements. Herein, the term “a plurality” may mean two or more unless it is specifically defined otherwise. The disclosure is described below in more detail with some embodiments.

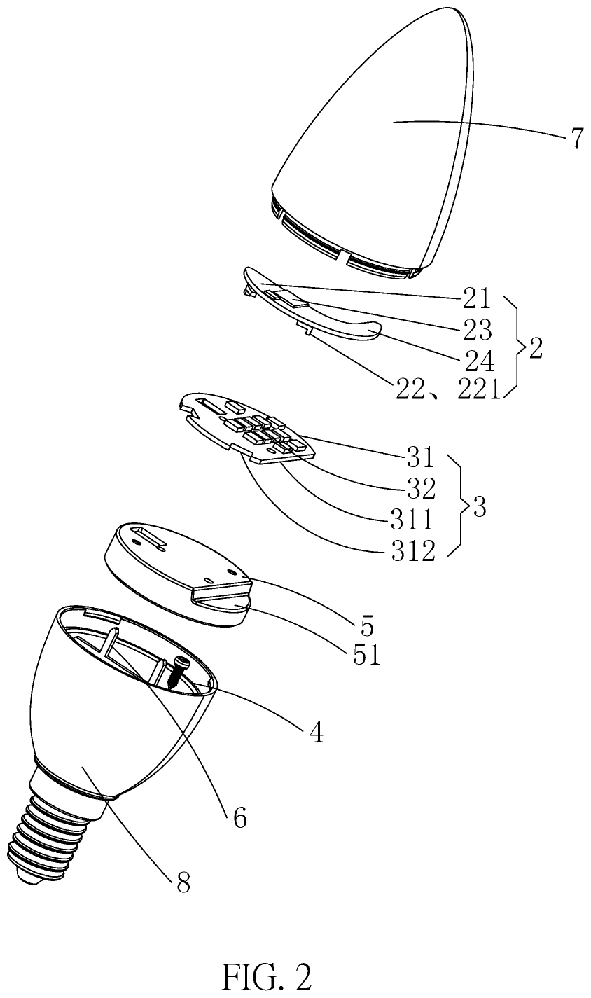

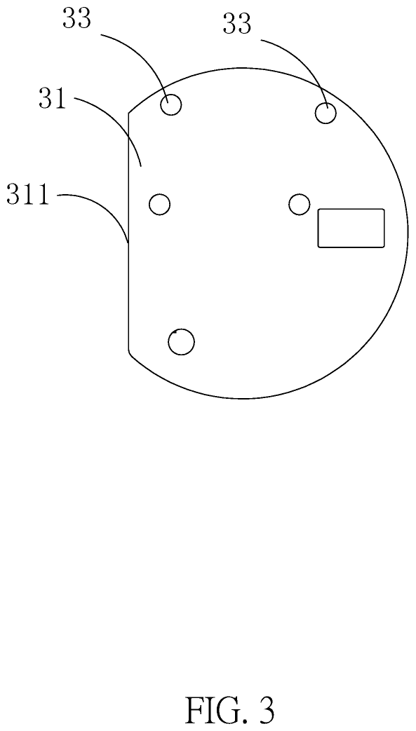

FIG. 2 to FIG. 4 illustrate a lamp according to an embodiment of the present disclosure.

As shown in FIG. 2 to FIG. 4, an embodiment provides a lamp able to transceive signals to exchange data with an external terminal and further realize functions of the Internet of Things (IoT).

The lamp may include an assembly 2 and a light source board assembly 3.

The antenna assembly 2 may include a radio frequency board 21, a plurality of first ground connection portion 22 disposed on the radio frequency board 21, a radio frequency module 23 and an antenna 24. The radio frequency module 23 and the antenna 24 may be integrated on the radio frequency board 21 and may be respectively connected to the first ground connection portion 22. The first ground connection portion 22 may be connected to ground portions of other parts of the lamp such as a base board, a heat dissipation part or a fixing cover of the lamp.

The light source board assembly 3 may include a base board 31 and a light source 32 disposed on the base board 31. The radio frequency board 21 may be disposed to stack on the base board 31. The light source 32 may be disposed to be not covered by the radio frequency board 21.

The lamp provided by an embodiment may have technical effects described below.

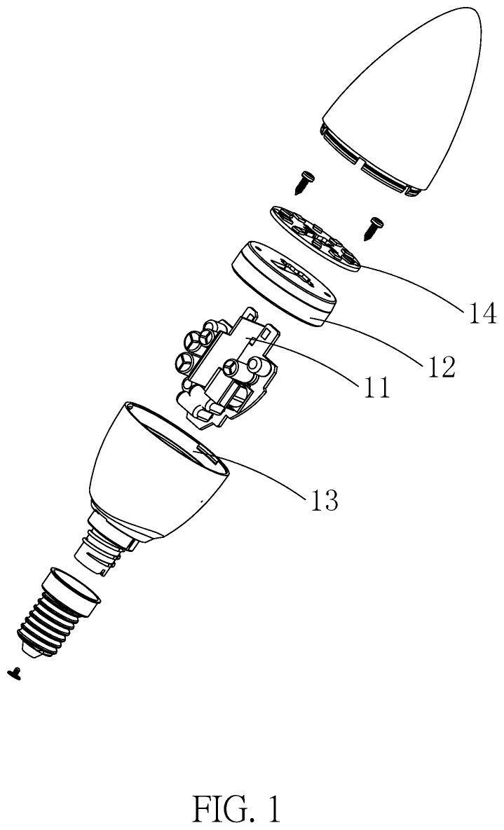

First, the radio frequency board 21 integrated with the radio frequency module 23 and the antenna 24 may be disposed to stack on the base board 31, and the first ground connection portion disposed on the radio frequency board 21 may be connected to other parts of the lamp, so the other parts of the lamp may be used as antenna radiation parts. Hence, the radio frequency board 21 may transceive signals without being blocked, the signals may be strong to make stable communications. Second, regarding prior art shown in FIG. 1, a lamp of prior art may have a radio frequency board 11 inserted through a light source board 14 where an antenna and a radio frequency module are integrated on the radio frequency board 11; however, the radio frequency board 21 of the present disclosure may not pass through the base board 31. In other words, it is unrequired to cut an opening on the base board 31 for inserting the radio frequency board 21, so manufacture process may be simpler. Moreover, the radio frequency board 21 integrated with the radio frequency module 23 and the antenna 24 may independently transceive signals to exchange data to achieve effects of an internet of things (IoT) lamp, and the highly integrated radio frequency board 21 may facilitate mass production and subsequent installation. Furthermore, according to prior art, the radio frequency board 11 may protrude excessively high so as to block light from the light source board 14 and reduce light efficiency of the light source board 14; however, according to the present disclosure, the radio frequency board 21 may be disposed to stack on the base board 31 instead of protruding on the base board 31. Hence, according the present disclosure, light emitted from the light source 32 may not be blocked by the radio frequency board 21, and the light efficiency of the light source 32 may be improved.

According to a first ground type of the antenna assembly, specifically, the light source board assembly 3 may further include a second ground connection portion 33 disposed on the base board 31. The first ground connection portion 22 may be connected to the second ground connection portion 33 correspondingly. The radio frequency board 21 may be directly stuck to the base board 31. The first ground connection portion 22 on the radio frequency board 21 may be connected to the second ground connection portion 33 on the base board 31.

Specifically, the lamp may further include a heat dissipation part 4 connected to the base board 31. The material of the heat dissipation part 4 may be preferably metal, such as aluminum. The base board 13 may be connected to the heat dissipation part 4, and the radio frequency board 21 may be connected to the base board 31, so the electrostatic path of the lamp having the antenna assembly 2 may be improved. Static electricity may flow through the radio frequency board 21 to the base board 31, and then flow from the base board 31 to the heat dissipation part 4. That is to say, the static electricity of the light source 32 may be discharged to the heat dissipation part 4.

Optionally, the second ground connection portion 33 may be welded to the first ground connection portion 22, and the second ground connection portion 33 may be screwed to the heat dissipation part 4.

The specific connections of an internal circuit of the foresaid lamp may be as follows.

A driver assembly of the light source 32 may be connected to the circuit of the base board 31. The radio frequency board 21 may be connected to the circuit of the base board 31. The copper of the radio frequency module 23 may be welded to ground copper of an upper radio frequency pin of the base board 31 at a plurality of points. The upper pin ground of the base board 31 may be connected to a plurality of screws and nuts, and be electrically connected to other structures of the heat dissipation part 4 through the screws. The base board 31 and the heat dissipation part 4 may be connected to one another by the locking effect of the screws and be electrically connected to one another.

Hence, according to an embodiment, the whole lamp may be assembled and integrated to be an antenna system, and metal parts other than the radio frequency board 21 may be a portion of an antenna. A radiation part of the antenna may be out of the metal structure of the light source board, and the metal structure of the whole lamp may be a ground of the antenna.

According to a second ground type of the antenna assembly, specifically, like the first ground type, the light source board assembly 3 may further include the second ground connection portion 33 disposed on the base board 31, and the first ground connection portion 22 may be connected to the second ground connection portion 33 correspondingly. The radio frequency board 21 may be directly stuck to the base board 31. The first ground connection portion 22 on the radio frequency board 21 may be connected to the second ground connection portion 33 on the base board 31.

Unlike the first ground type, the lamp may further include a fixing cover 5 connected to the radio frequency board 21. The fixing cover 5 may be used to fix the base board 31 and the radio frequency board 21 and discharge static electricity.

Optionally, the radio frequency board 21 may be welded back to the base board 31, and The second ground connection portion 33 on the base board 31 may be screwed to the fixing cover 5. According to an embodiment, the first ground connection portion 22 on the radio frequency board 21, the second ground connection portion 33 on the base board 31 and the fixing cover 5 may be connected to one another to be coupled to metal structures, and the electrostatic path of the lamp may be improved. Static electricity may flow through the radio frequency board 21 to the base board 31, then flow from a screw connected with the base board 31 to the fixing cover 5, and then flow to other parts of the lamp (e.g., the heat dissipation part 4) connected to the fixing cover 5.

According to a third ground type of the antenna assembly, unlike the first ground type and the second ground type, the first ground connection portion 22 on the radio frequency board 21 may not be connected to a ground portion of the base board 31. In other words, the first ground connection portion 22 may be disposed to pass through the base board 31 and be directly connected to other parts of the lamp.

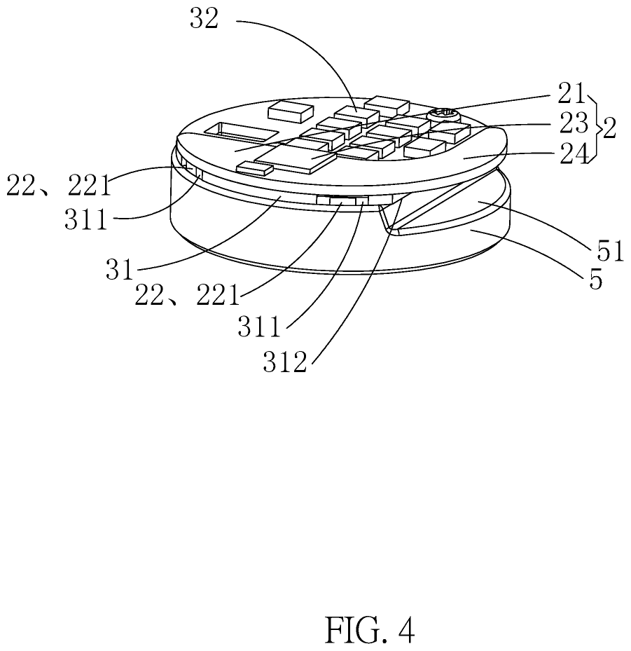

As shown in FIG. 4, the first ground connection portion 22 may include a spring terminal 221, and the spring terminal 221 may pass through the base board 31 to contact the fixing cover 5. Specifically, according to an embodiment, a plurality of exposed copper points may be selected from the first ground connection portion 22 on the radio frequency board 21 to be welded to a plurality of spring terminals 221. The base board 31 may have a pass-through slot 311 on a location corresponding to the spring terminals 221. The pass-through slot 311 may be used to accommodate the spring terminal 221. The spring terminal 221 may contact the pass-through slot 311 or may not contact the pass-through slot 311.

The spring terminal 221 may directly pass through the base board 31 to contact the fixing cover 4 to connect the first ground connection portion 22 of the radio frequency board 21 to the fixing cover 5. Hence, the antenna 24 may be connected to a ground, and static electricity may be discharged to the fixing cover 5. According to this solution, the use of screws to ground may be not required. Compared with the first ground type and the second ground type, the use of screws to ground may be reduced, and the installation process may be simplified.

According to each of the three ground types mentioned above, the base board 31 may have a gap 312 used for a part of the radio frequency board 21 to be exposed, and the antenna 24 may be integrated on the part of the radio frequency board 21. The gap 312 may form a necessary space required by the antenna 24 to transceive signals, and further reduce the influence of the surrounding parts on the radiation of the antenna 24.

Furthermore, the fixing cover 5 may have an open slot 51 on a location corresponding to the antenna 21. The open slot 51 may be used for not blocking the antenna 21 to prevent the fixing cover 5 from blocking signals transceived by the antenna 21.

Furthermore, the lamp may further include a driver assembly 6 connected to the antenna assembly 2.

Furthermore, the lamp may further include a lamp holder 8 and a lamp cover 7. The lamp cover 7 may be covered on the lamp holder 8 to accommodate the antenna assembly 2, the driver assembly 3 and so on. Light may transmit through lamp cover 7 for illumination.

In summary, according to an embodiment, the base board 31 may need to be electrically connected to the heat dissipation part 4 or the fixing cover 5, so a base board material without oxide layer treatment (i.e. insulation treatment) on the back may be used. Hence, the back of the base board 31 may be conductive, smooth and with good thermal conductivity. According to prior art, the base board 31 is not electrically connected to the heat dissipation part 4, so a non-conductive oxide layer is formed on the back. Hence, according to prior art, more manufacture processes must be performed than manufacturing the base board 31 of this embodiment. According to prior art, the antenna assembly 2 need to be disposed away from metal parts to avoid antenna effect and reducing transmission efficiency. However, according to an embodiment of the present disclosure, the whole lamp may be assembled and integrated to be an antenna system, and metal parts other than the antenna assembly 2 (e.g., the base board 31, the heat dissipation part 4 and the fixing part 5) may be a portion of the antenna 24. Therefore, a radiation part of the antenna 24 may be out of the metal structure, and the metal parts of the whole lamp may act as a radiation ground of the antenna 24. The radiation ability of the antenna assembly 2 may be enhanced, the radiation may be improved, and the signal may be transceived more stably.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lamp comprising:
an antenna assembly comprising a radio frequency board, a first ground connection portion disposed on the radio frequency board, a radio frequency module and an antenna wherein the radio frequency module and the antenna are integrated on the radio frequency board and are respectively connected to the first ground connection portion; and
a light source board assembly comprising a base board and a light source disposed on the base board wherein the radio frequency board is disposed to stack on the base board, the light source is disposed to be not covered by the radio frequency board, and the first ground connection portion is connected to ground portions of other parts of the lamp.

2. The lamp of claim 1, wherein the base board has a gap configured for a part of the radio frequency board to be exposed, and the antenna is integrated on the part of the radio frequency board.

3. The lamp of claim 1, wherein the light source board assembly further comprises a second ground connection portion disposed on the base board, and the second ground connection portion is connected to the first ground connection portion correspondingly.

4. The lamp of claim 3, wherein the base board has a gap configured for a part of the radio frequency board to be exposed, and the antenna is integrated on the part of the radio frequency board.

5. The lamp of claim 3 further comprising a heat dissipation part connected to the base board.

6. The lamp of claim 5, wherein the base board has a gap configured for a part of the radio frequency board to be exposed, and the antenna is integrated on the part of the radio frequency board.

7. The lamp of claim 5, wherein the second ground connection portion is welded to the first ground connection portion, and the second ground connection portion is screwed to the heat dissipation part.

8. The lamp of claim 7, wherein the base board has a gap configured for a part of the radio frequency board to be exposed, and the antenna is integrated on the part of the radio frequency board.

9. The lamp of claim 5, wherein the radio frequency board is connected to the base board, static electricity flows through the radio frequency board to the base board, and then flows from the base board to the heat dissipation part.

10. The lamp of claim 3 further comprising a fixing cover connected to the radio frequency board.

11. The lamp of claim 10, wherein the base board has a gap configured for a part of the radio frequency board to be exposed, and the antenna is integrated on the part of the radio frequency board.

12. The lamp of claim 10, wherein the second ground connection portion is welded to the first ground connection portion, and the second ground connection portion is screwed to the fixing cover.

13. The lamp of claim 12, wherein the base board has a gap configured for a part of the radio frequency board to be exposed, and the antenna is integrated on the part of the radio frequency board.

14. The lamp of claim 10, wherein the first ground connection portion comprises a spring terminal, and the spring terminal passes through the base board to contact the fixing cover.

15. The lamp of claim 14, wherein the base board has a gap configured for a part of the radio frequency board to be exposed, and the antenna is integrated on the part of the radio frequency board.

16. The lamp of claim 10, wherein the base board has a pass-through slot configured for the spring terminal to pass through.

17. The lamp of claim 16, wherein the base board has a gap configured for a part of the radio frequency board to be exposed, and the antenna is integrated on the part of the radio frequency board.

18. The lamp of claim 10, wherein the fixing cover has an open slot corresponding to the antenna.

19. The lamp of claim 18, wherein the base board has a gap configured for a part of the radio frequency board to be exposed, and the antenna is integrated on the part of the radio frequency board.

20. The lamp of claim 10, wherein the fixing cover is configured to fix the base board and the radio frequency board and discharge static electricity.
